(19) United States
(12) Patent Application Publication
(10) Pub. No.: US 2012/0073052 A1
(43) Pub. Date: Mar. 29, 2012

(54) PNEUMATIC POWERED DECK SECTION

(76) Inventor: Eric R. Meyer, Greensburg, IN (US)

(21) Appl. No.: 12/985,951

(22) Filed: Jan. 6, 2011

Related U.S. Application Data
(63) Continuation-in-part of application No. 12/893,037, filed on Sep. 29, 2010, now abandoned.

(51) Int. Cl. A61G 7/015; A61G 7/00

(52) U.S. Cl. 5/615

(57) ABSTRACT

An actuator for a extendable deck section of a patient support apparatus comprises a flexible inflatable vessel, a variable length enclosure having a first end coupled to a base portion of an extendable deck section and a second end coupled to an extender portion of the extendable deck section.

### CROSS REFERENCE TO RELATED APPLICATIONS

This application is a continuation-in-part of U.S. patent application Ser. No. 12/893,037, filed Sep. 29, 2010 and titled BED FRAME WITH A BLADDER POWERED EXTENSION, the disclosure of which is hereby incorporated by reference herein.

### BACKGROUND

The present disclosure is related to patient support apparatus having an extendable deck section. More specifically, the present disclosure is related to a patient support apparatus having an extendable deck section that is powered by a pneumatic actuator.

Patient support apparatuses, such as hospital beds, for example, may include deck sections that are expandable or retractable to vary the size of the deck section. For example, a patient support apparatus may include a deck section to support the lower legs with the foot deck section being extendable or retractable to act as a foot prop to support the foot of a patient on the patient support apparatus. In patient support apparatuses that move to a chair egress position, such as the Hill-Rom® TotalCare® bed, the foot deck section may retract to prevent interference with the floor when the foot deck section is lowered to a generally vertical position.

Extension and retraction of a deck section has been accomplished by actuators such as electromechanical actuators or hydraulic cylinder assemblies. In the case of electromechanical actuators, the weight and cost of the actuator, as well as the size, results in excessive performance and cost for the application. In the case of hydraulic cylinders, the operational of the cylinder is powered by a central hydraulic system, which may operate at relatively high pressures relative to the load required to extend the foot deck section. This is because the hydraulic system is sized to the larger loads placed on other cylinders in the system which lift major components of the bed. The use of hydraulic fluid in the system presents sanitary issues if a leak develops and each connection or fitting increases the risk of reliability problems in a pressurized hydraulic system.

### SUMMARY

The present application discloses one or more of the features recited in the appended claims and/or the following features which, alone or in any combination, may comprise patentable subject matter.

According to the present disclosure, an actuator for a extendable deck section of a patient support apparatus comprises a flexible inflatable vessel, a variable length enclosure having a first end coupled to a base portion of an extendable deck section and a second end coupled to an extender portion of the extendable deck section, and a bias member urging the first and second ends together.

The patient support apparatus may comprise a lower frame, an upper frame movable relative to the lower frame, and the deck section may be supported on the upper frame. The deck section may define a first support surface having a variable size and include a base and an extender movable relative to the base to vary the size of the first support surface.

The flexible inflatable vessel may have a cylindrical shape. The flexible inflatable vessel may define an expandable interior space. The flexible inflatable vessel may include a pleated sidewall. In some embodiments, the bias member may be positioned in the expandable interior space.

The base of the deck section may be pivotable relative to the upper frame.

The enclosure may include a first portion and a second portion, the second portion telescopically engaged with the first portion to extend and retract relative thereto to change the length of the enclosure.

The deck section may be a first deck section and the patient support apparatus may further comprise a second deck section defining a second support surface. The first deck section may be pivotable relative to the second deck section between a first position in which the first support surface and second support surface are separated by an obtuse angle and a position in which the first support surface and second support surface form a reflex angle.

The actuator may be a first actuator and the patient support apparatus may further comprise a second actuator. The first deck section may be supported at least in part by the second actuator.

The patient support apparatus may further comprise a source of pressurized air. The source of pressurized air may provide a flow of pressurized air to the flexible inflatable vessel to cause the flexible inflatable vessel to expand. The patient support apparatus may further comprise a selectively actuable valve controlling the flow from the source of pressurized air to the flexible inflatable vessel. The source of pressurized air may be operable to supply pressurized air to the flexible inflatable vessel and remove air from the flexible inflatable vessel. The source of pressurized air may include a switching valve that switches the flow of air from the source of pressurized air to the flexible inflatable vessel between a positive pressure and a negative pressure.

The patient support apparatus may further comprise a control system that controls the operation of the selectively actuable valve and the source of pressurized air to control the extension and retraction of the first actuator. The control system may include a position sensor that provides a signal that is indicative of the position of the extender of the first deck section relative to the base of the first deck section.

The control system may further comprise user inputs that provide a signal indicative of an expected direction of movement of the extender relative to the base. The control system may monitor the signals from the user inputs and position sensor and output signals to the selectively actuable valve, source of pressurized air, and switching valve in response to the signals from the user inputs and position sensor.

### BRIEF DESCRIPTION OF THE DRAWINGS

The detailed description particularly refers to the accompanying figures, in which:

FIG. 1 is a perspective view of a patient support apparatus including a foot deck section that is extendable to expand the surface area of the foot deck section.

FIG. 2 is a side view of a portion of the patient support apparatus of FIG. 1 with the foot deck section in a raised position and an actuator positioned on the foot deck section extended to extend the length of the foot deck section;

FIG. 3 is view similar to FIG. 2 with the foot deck section partially lowered and partially retracted;

FIG. 4 is view similar to FIGS. 2 and 3 with the foot deck section lowered and retracted;

FIG. 5 is a cross-sectional view of the foot deck section and the actuator used to extend and retract the foot deck section with the foot deck section in a fully extended position;

FIG. 6 is similar to FIG. 5 but with the foot deck section fully retracted; and

FIG. 7 is a diagrammatic view of a portion of the control system of the patient support apparatus of FIG. 1.

### DETAILED DESCRIPTION OF THE DRAWINGS

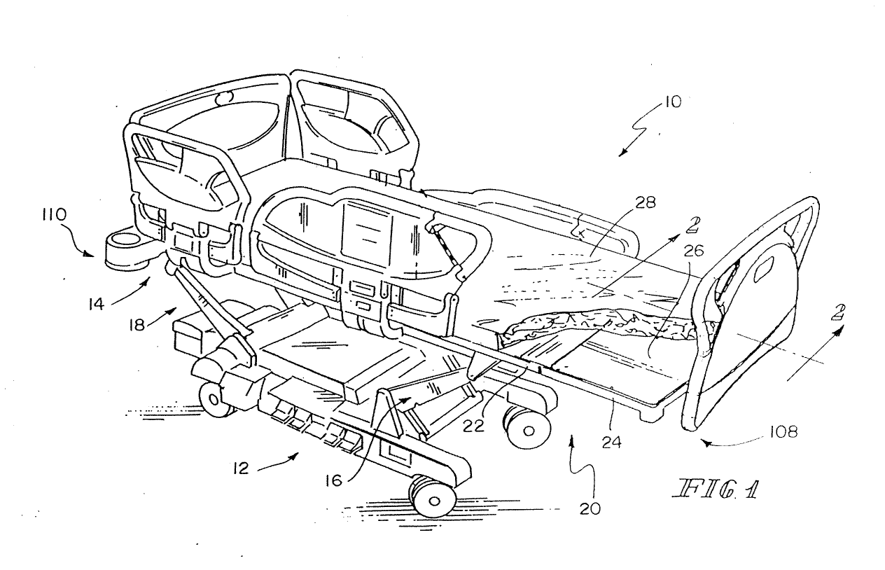

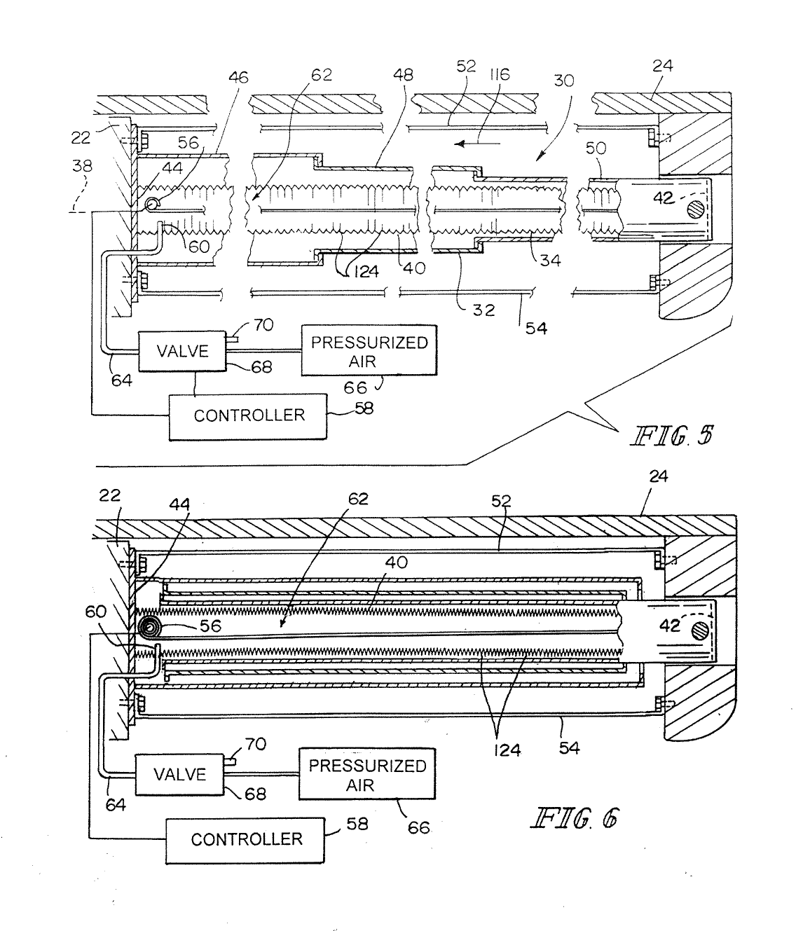

A patient support apparatus, illustratively embodied as a hospital bed 10 shown in FIG. 1, includes a lower frame 12 and an upper frame 14 movable relative to the lower frame 12. The upper frame 14 is supported on two pairs of lift arms 16 and 18, respectively. The lift arms 16 are positioned generally at a foot end 108 of the lower frame 12 and the lift arms 18 are positioned generally at a head end 110 of the lower frame 12. Reference to the foot end 108 and the head end 110 of the patient support apparatus 10 is intended to provide an orientation reference and does not refer to any specific surface or element of the patient support apparatus 10. The hospital bed 10 of FIG. 1 is movable from a conventional bed position as shown in FIG. 1 to a chair egress position in which the foot deck section 20 of the hospital bed 10 is lowered to a generally vertical position as shown in FIG. 2. The patient supported on the hospital bed 10 may egress or exit the hospital bed 10 from the foot end 108 of the hospital bed 10 in a seated position.

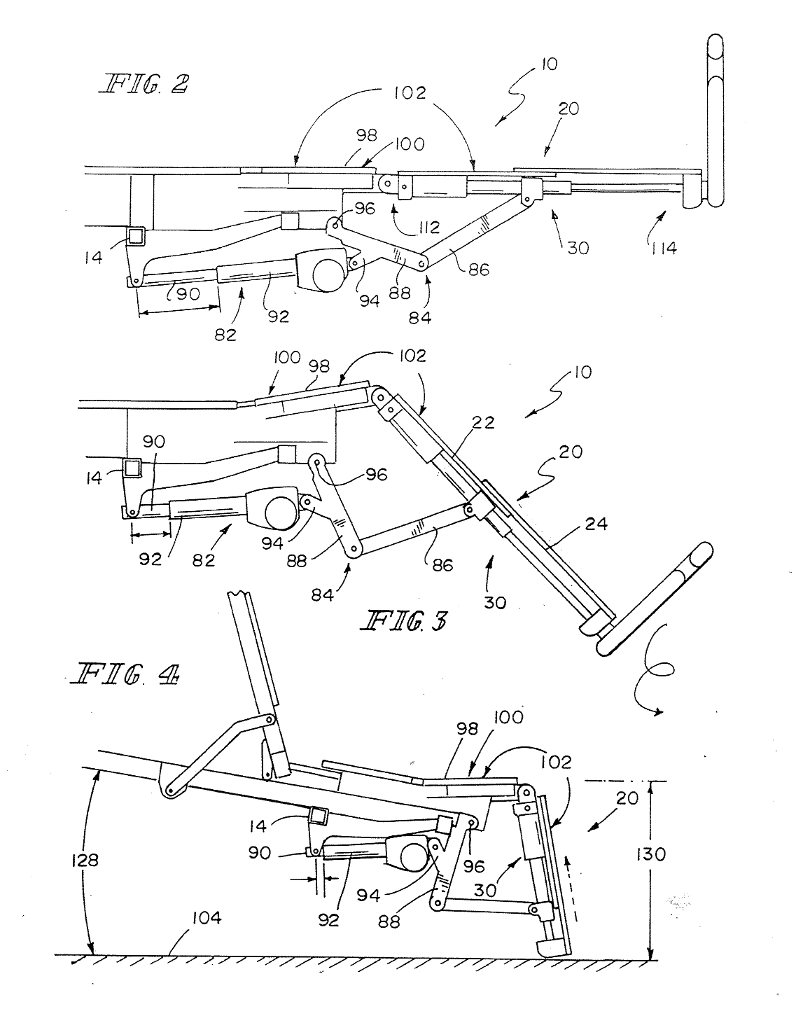

The foot deck section 20 of the patient support apparatus 10 includes a base 22 and an extender 24 movable relative to the base 22 to vary the length of the foot deck section 20. The foot deck section 20 defines a support surface 26 which supports at least a portion of a mattress 28. The support surface 26 is variable in size and increases in size as the extender 24 moves relative to the base 22 to increase the length of the foot deck section 20. The extender 24 is supported from the base 22 and movable relative to base 22 between a fully extended position as shown in FIG. 1 and a retracted position as shown in FIG. 4.

Referring now to FIG. 2, the foot deck section 20 changes in length due when acted on by an actuator 30 that is connected at a first end 112 to the base 22 of the foot deck section 20. A second end 114 of the actuator 30 is connected to the extender 24. The actuator 30 extends and retracts under pneumatic power and thereby acts on the foot deck section 20 to vary the length of the foot deck section 20 and the size of the support surface 26. Referring now to FIG. 5, the actuator 30 includes a variable length enclosure 32 and a flexible inflatable vessel, illustratively embodied as a bladder 34, positioned in an interior space 36 of the variable length enclosure 32. The bladder 34 is constrained by the variable length enclosure 32 so that expansion of the bladder 34 causes the variable length 32 to expand along an axis 38.

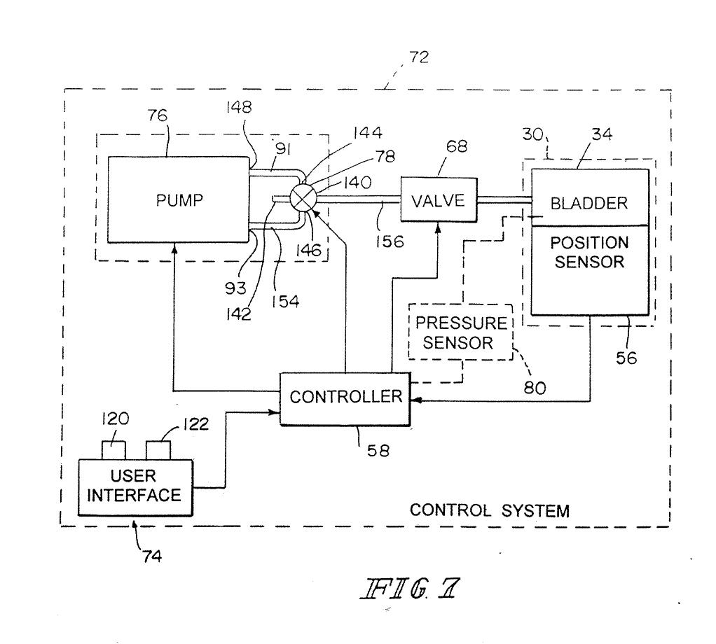

Referring to FIGS. 5 and 6, the bladder 34 includes a pleated side wall 40 that tends to limit the expansion of the bladder 34 along the axis 38. As the bladder 34 expands the pressure inside the bladder 34 acts on two end walls 42 and 44 of the bladder 34 to urge the variable length enclosure 32 to extend. The variable length enclosure 32 includes a base 46, an extension 48, and a head 50. The extension 48 moves telescopically with respect to the base 46. The head 50 moves telescopically with respect to the extension 48. As the bladder 34 expands, the extension 48 extends from the base 46 while the head 50 extends from the extension 48. Movement of the actuator 30 is constrained by a pair of bias members 52, 54 which tend to urge the extender 24 toward the base 22 of the foot deck section 20 as indicated by arrow 116. Under normal conditions, the force developed by the pressure in the bladder 34 acting on end walls 42 and 44 is in equilibrium with the bias force of the bias members 52, 54 to maintain the position of the extender 24 relative to the base 22 of the foot deck section 20.

A position sensor illustratively embodied as a string potentiometer 56 is positioned in an interior space 62 inside of the bladder 34 and measures the magnitude of extension of the bladder 34 with one end of the string potentiometer being coupled to the end wall 42 of the bladder 34 and the string potentiometer 56 body secured to the end wall 44 of the bladder 34 adjacent the base 22 of the foot deck section 20. The string potentiometer 56 is part of a control system 72 and is electrically coupled to a controller 58 of the hospital bed 10. The controller 58 utilizes the input from the string potentiometer 56 to control the inflation of the bladder 34 and thereby control the position of the extender 24 relative to base 22 of the foot deck section 20.

The bladder 34 includes a fitting 60 provided passageway into the interior space 62 of the bladder 34. A flow path for pressurized air is provided by a hose 64 which is secured to the fitting 60, the hose 64 providing a flow path for air from a pressurized air source 66. The flow of air between the pressurized air source 66 and the bladder 34 is controlled by a valve 68 which is coupled to the controller 58 such that the controller 58 operates the valve 68 to open or close the flow path between the pressurized air source 66 and the bladder 34. In the illustrative embodiment, the valve 68 is a three position valve. The valve 68 permits flow between the pressurized air source 66 and the bladder 34 in a first position. The valve 68 closes the flow path from the bladder 34 through the hose 64 such that the bladder is a closed volume when the valve is a second position. The valve 68 vents the bladder 34 to atmosphere through a vent 70 in the valve 68 when the valve is in a third position. When the valve 68 vents the bladder 34, the bias members 52, 54 urge the extender 24 toward the base 22 of the foot deck section 20. The movement of the extender 24 toward the base 22 urges the bladder 34 to collapse and the air in the interior space 62 of the bladder 34 to be exhausted through the vent 70 of the valve 68.

The diagrammatic representation of a portion of the control system 72 of the patient support apparatus 10 is shown in FIG. 7. The controller 58 receives input from the position sensor 56 and a user interface 74. The controller 58 processes the inputs from the user interface 74 and the position sensor 56 to determine the proper operation of the valve 68 and the pressurized air source 66 to control the operation of the actuator 30. The pressurized air source 66 includes a pump 76 and a switching valve 78. The switching valve 78 includes four outlets 140, 142, 144, and 146. The pump 76 includes an inlet 148 coupled to the outlet 144 of the switching valve 78 by a hose 91. In addition, the pump 76 also includes an outlet 93 which is connected to the inlet 146 of the switching valve 78 by a hose 154. The outlet 140 of the switching valve 78 is connected to a hose 156 which provides a flow path from the pressurized air source 66 to the valve 68. The outlet 142 of the switching valve 78 is open to atmosphere to provide a flow path for drawing air into the system or exhausting air to atmosphere depending on the position of the switching valve 78.

The user interface 74 includes user input devices 120, 122 used by a user to indicate a direction of movement of the extender 24 relative to the base 22 of foot deck section 20. The user input device 120 is activated by the user to indicate that the foot deck section 20 should be extended. The user input device 122 is used by the user to indicate that the foot deck section 20 should be retracted. The signals from the user input device 120, 122 are considered by the controller 58 in determining how to operate the pressurized air source 66 and the valve 68. The information from the position sensor 56 is also used to determine the appropriate operation of the pressurized air source 66 and valve 68. For example, if the foot deck section 20 has been extended or retracted to a mechanical limit, as determined by the position sensor 56, then the controller will turn the pump 76 off and close the valve 68 to maintain the position of the extender 24 relative to the base 22 of the foot deck section 20.

Under normal operation, the switching valve 78 is positioned such that air flows into the switching valve 78 through the outlet 142. The air then flows through the outlet 144 of switching valve 78 through the hose 91 into the inlet 148 of the pump 76. The pump 76 pressurizes the air and exhausts the air through the outlet 93 of the pump 76 and hose 154 to the outlet 146 of the switching valve 78. The pressurized air then flows through the outlet 140 of the switching valve 78 and through the hose 156 to the valve 68. In this position, the pressurized air source 66 provides a positive pressure flow of air to the valve 68 and ultimately the bladder 34. In some embodiments, the switching valve 78 may be positioned to reverse the flow described above such that pressurized air source 66 develops a negative pressure in the flow path to the bladder 34. The negative pressure configuration will then cause the bladder 34 to contract.

Referring now again to FIGS. 3 and 4, the end wall 44 of the bladder 34 is coupled to the base 46 of the variable length enclosure 52 and the end wall 42 of the bladder 34 is coupled to the head 50 of the variable length enclosure 52. In the illustrative embodiment, the bladder 34 is glued to the head 50 and base 46 of the variable length enclosure 52. In other embodiments, the bladder 34 may be secured to the head 50 and a base 46 of the bladder 34 by a fastener. When the switching valve 78 is positioned such that the pressurized air source 66 evacuates the bladder 34, the extender 24 is drawn toward the base 22 of the foot deck section 20 by the action of the bladder 34 under a negative pressure. In some embodiments, the bias members 52, 54 are omitted and the extender 24 is engaged with the base 22 such that the position of the extender 24 relative to base 22 is maintained without the need for the bias members 52, 54 to maintain the equilibrium condition. It should also be understood, that the use of a negative pressure from the pressurized air source 66 may be used in cooperation with the bias members 52, 54 with the negative pressure being used to contract the bladder 34 more rapidly than would be achieved by having the bias members 52, 54 acting on the bladder 34 without the action of the negative pressure.

In the illustrative embodiment, the pressurized air source 66 is a compressor utilized by the hospital bed 10 to operate the mattress 28 supported on the hospital bed 10. This avoids the cost of an additional motor required by a direct current (DC) or an alternating current (AC) electromechanical actuator. Use of pressurized air from a pressurized air source 66 positioned on the hospital bed 10 also avoids the requirement for a hydraulic actuator operating at the relatively high pressures necessary for a central hydraulic system in a hydraulically powered hospital bed. In some cases, the operation of a variable length of foot deck section, such as foot deck section 20 does not experience as many cycles as compared to the operation of other actuator driven functions of a hospital bed. Therefore, the use of a flexible variable vessel such as the bladder 34 avoids unnecessary costs and complexity associated with using a traditional hydraulic or electromechanical actuator. While the illustrative embodiment shows the use of the actuator 32 power the extension and retraction of a foot deck section, it should be understood that an actuator having a structure similar to actuator 30 may be used to extend and retract other expandable sections of a patient support apparatus.

In the illustrative embodiment, the flexible inflatable vessel includes urethane coated nylon fabric that is ultrasonically welded to form the bladder structure with the end walls 42, 44 and side wall 40. It should be understood that in other embodiments the flexible inflatable vessel may be molded from urethane or other polymer with the end walls 42, 44 and side wall 40 being formed during the molding process. In addition, the pleats 124 in the side wall 40 may be formed in the molding process. Those of skill in the art will appreciate that molding the flexible inflatable vessel may permit the side wall 40 to be formed such that it is biased to a contracted position. In such an embodiment, the bias members 52, 54 may be omitted with the bias of the side wall 40 serving to urge the retraction of the actuator 30.

In some embodiments, the position sensor may be embodied as something other than a string potentiometer. For example, a slide potentiometer may be positioned so that movement of either portions of the variable length enclosure 52 or the extender 24 relative to the base 22 of the foot deck section 20 may be measured to determine the magnitude of extension of the foot deck section 20. Any of a number of linear position sensors may be used to determine the magnitude of extension of the foot deck section 20.

In some embodiments, the position sensor may be omitted and the position of the foot deck section 20 extender 24 relative to the base 22 may be determined by a pressure sensor 80 coupled to the controller 58 and operable to read a pressure in the bladder 34. When a pressure sensor 80 is used, the pressure in the bladder 34 may be correlated to a position of the extender 24 relative to the base 22 of foot deck section 20.

Extension and retraction of the foot deck section 20 may be used to modify the length of the hospital bed 10 to accommodate patients of different heights, or may be used to retract the foot deck section 20 when the foot deck section 20 is moved to a generally vertical position as shown in FIG. 4. As shown in FIGS. 2-4, the foot deck section 20 is supported on the upper frame 14 and pivotal relative to the upper frame 14. A linear actuator 82 rotates a crank 84 which supports the foot deck section 20 through an arm 86 which is pivotally coupled to the foot deck section 20 and a link 88 of the crank 84. The linear actuator 82 includes a rod 90 which extends and retracts relative to a body 92, with the rod 90 acting on a link 94 of the crank 84 which causes the crank to rotate about an axis 96. Operation of a linear actuator 82 causes the foot deck section 20 to move relative to a thigh deck section 98 such that a surface 100 of the thigh deck section 98 and the surface 26 of the foot deck section 20 form a variable angle 102. The angle 102 between surface 26 and surface 100 is variable a straight angle being formed between the surface 26 and 100 when the foot deck section 20 is in a position to support a patient in a supine position on the hospital bed 10. As shown in FIG. 4, the angle 102 may be as great as approximately 270° when the foot deck section 20 is lowered to position the hospital bed 10 in the chair egress position. In the chair egress position shown in FIG. 4, the foot deck section 20 is fully retracted to reduce the height 130 of the thigh deck section 98 from the floor 104 when the upper frame 14 is lowered to the chair egress position.

The upper frame 14 is tiltable relative to the floor 104 to increase from an angle 128 of about 97°. In this attitude, the thigh deck section 98 is positioned approximately horizontally as shown in FIG. 4 to form the chair egress position. With the foot deck section 20 fully retracted, the height 130 is reduced to provide a position for a patient to egress from the foot end 108 of the hospital bed 10.

Although certain illustrative embodiments have been described in detail above, variations and modifications exist within the scope and spirit of this disclosure as described and as defined in the following claims.

1. A patient support apparatus comprising
a lower frame,
an upper frame movable relative to the lower frame,
a first deck section supported on the upper frame, the first deck section defining a first support surface having a variable size, the first deck section including a base and an extender movable relative to the base to vary the size of the first support surface, and
a first actuator coupled to the first deck section, the first actuator including a flexible inflatable vessel, a variable length enclosure having a first end coupled to the base and a second end coupled to the extender, and a bias member urging the first and second ends together.

2. The patient support apparatus of claim 1, wherein the flexible inflatable vessel has a cylindrical shape.

3. The patient support apparatus of claim 1, wherein the flexible inflatable vessel defines an expandable interior space.

4. The patient support apparatus of claim 1, wherein the bias member is positioned in the expandable interior space.

5. The patient support apparatus of claim 1, wherein the flexible inflatable vessel includes a pleated sidewall.

6. The patient support apparatus of claim 1, wherein the base of the deck section is pivotable relative to the upper frame.

7. The patient support apparatus of claim 1, wherein the enclosure includes a first portion and a second portion, the second portion telescopically engaged with the first portion to extend and retract the enclosure.

8. The patient support apparatus of claim 1, wherein the patient support apparatus further comprises a second deck section defining a second support surface, the first deck section pivotable relative to the second deck section between a first position in which the first support surface and second support surface are separated by an obtuse angle and a position in which the first support surface and second support surface form a reflex angle.

9. The patient support apparatus of claim 8, wherein the first deck section is supported at least in part by a second actuator.

10. The patient support apparatus of claim 9, wherein the patient support apparatus further comprises a source of pressurized air, the source of pressurized air providing a flow of pressurized air to the flexible inflatable vessel to cause the flexible inflatable vessel to expand.

11. The patient support apparatus of claim 10, wherein the patient support apparatus further comprises a selectively actuable valve controlling the flow from the source of pressurized air to the flexible inflatable vessel.

12. The patient support apparatus of claim 11, wherein the source of pressurized air is operable to supply pressurized air to the flexible inflatable vessel and remove air from the flexible inflatable vessel.

13. The patient support apparatus of claim 12, wherein the source of pressurized air includes a switching valve that switches the flow of air from the source of pressurized air to the flexible inflatable vessel between a positive pressure and a negative pressure.

14. The patient support apparatus of claim 13, wherein the patient support apparatus further comprises a control system that controls the operation of the selectively actuable valve and the source of pressurized air to control the extension and retraction of the first actuator.

15. The patient support apparatus of claim 14, wherein the control system includes a position sensor that provides a signal that is indicative of the position of the extender of the first deck section relative to the base of the first deck section.

16. The patient support apparatus of claim 15, wherein the control system further comprises user inputs that provide a signal indicative of an expected direction of movement of the extender relative to the base.

17. The patient support apparatus of claim 16, wherein the control system monitors the signals from the user inputs and position sensor and outputs signals to the selectively actuable valve, source of pressurized air, and switching valve in response to the signals from the user inputs and position sensor.

18. The patient support apparatus of any preceding claim, wherein the first deck section is supported on the upper frame, at least in part, by a second actuator having a variable length.

19. The patient support apparatus of claim 1, wherein the patient support apparatus further comprises a source of pressurized air, the source of pressurized air providing a flow of pressurized air to the flexible inflatable vessel to cause the flexible inflatable vessel to expand.

20. The patient support apparatus of claim 19, wherein the source of pressurized air includes a switching valve that switches the flow of air from the source of pressurized air to the flexible inflatable vessel between a positive pressure and a negative pressure.
